(19) United States
(12) Patent Application Publication
(10) Pub. No.: US 2025/0200757 A1
(43) Pub. Date: Jun. 19, 2025

(54) TEMPORALLY-COHERENT IMAGE RESTORATION USING DIFFUSION MODEL

(71) Applicant: Samsung Electronics Co., Ltd., Suwon-si (KR)

(72) Inventors: Zhe Zhu, Irvine, CA (US); Tien C. Bau, Irvine, CA (US)

(21) Appl. No.: 18/782,692

(22) Filed: Jul. 24, 2024

Related U.S. Application Data
(60) Provisional application No. 63/610,950, filed on Dec. 15, 2023.

(51) Int. Cl. G06T 7/20; G06T 3/18

(52) U.S. Cl. CPC G06T 7/20; G06T 3/18

(57) ABSTRACT

A method includes obtaining, using at least one processing device of an electronic device, first and second image frames. The method also includes generating, using the at least one processing device, a first noise map for the first image frame. The method further includes determining, using the at least one processing device, motion information between the first image frame and the second image frame. The method also includes generating, using the at least one processing device, a second noise map for the second image frame based on the first noise map and the motion information. In addition, the method includes generating, using the at least one processing device, a first restored image frame based on the first image frame and the first noise map and a second restored image frame based on the second image frame and the second noise map using a trained diffusion model.

### CROSS-REFERENCE TO RELATED APPLICATION AND PRIORITY CLAIM

This application claims priority under 35 U.S.C. § 119(e) to U.S. Provisional Patent Application No. 63/610,950 filed on Dec. 15, 2023. This provisional patent application is hereby incorporated by reference in its entirety.

### TECHNICAL FIELD

This disclosure relates generally to image processing systems and processes. More specifically, this disclosure relates to temporally-coherent image restoration using a diffusion model.

### BACKGROUND

Diffusion models have achieved state-of-the-art results in various image synthesis tasks. A diffusion model can be used in image synthesis by randomly generating a noise map and using the diffusion model to map the noise map to a realistic image. Since diffusion models can be easily conditioned, the diffusion models can be effectively applied to various image restoration tasks, such as image inpainting or outpainting, image denoising, and image super-resolution. With the powerful image generation capabilities of diffusion models, their image synthesis results are often much more realistic than previous approaches.

### SUMMARY

This disclosure relates to temporally-coherent image restoration using a diffusion model.

In a first embodiment, a method includes obtaining, using at least one processing device of an electronic device, first and second image frames. The method also includes generating, using the at least one processing device, a first noise map for the first image frame. The method further includes determining, using the at least one processing device, motion information between the first image frame and the second image frame. The method also includes generating, using the at least one processing device, a second noise map for the second image frame based on the first noise map and the motion information. In addition, the method includes generating, using the at least one processing device, a first restored image frame based on the first image frame and the first noise map and a second restored image frame based on the second image frame and the second noise map using a trained diffusion model.

In a second embodiment, an electronic device includes at least one processing device configured to obtain first and second image frames and generate a first noise map for the first image frame. The at least one processing device is also configured to determine motion information between the first image frame and the second image frame and generate a second noise map for the second image frame based on the first noise map and the motion information. The at least one processing device is further configured to generate a first restored image frame based on the first image frame and the first noise map and a second restored image frame based on the second image frame and the second noise map using a trained diffusion model.

In a third embodiment, a non-transitory machine readable medium contains instructions that when executed cause at least one processor of an electronic device to obtain first and second image frames and generate a first noise map for the first image frame. The non-transitory machine readable medium also contains instructions that when executed cause the at least one processor to determine motion information between the first image frame and the second image frame and generate a second noise map for the second image frame based on the first noise map and the motion information. The non-transitory machine readable medium further contains instructions that when executed cause the at least one processor to generate a first restored image frame based on the first image frame and the first noise map and a second restored image frame based on the second image frame and the second noise map using a trained diffusion model.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIGS. 2 and 3 illustrate example forward and reverse diffusion processes in accordance with this disclosure;

FIG. 4 illustrates an example architecture supporting temporally-coherent image restoration using a diffusion model in accordance with this disclosure;

FIG. 5 illustrates an example process for modifying noise maps to support temporally-coherent image restoration using a diffusion model in accordance with this disclosure; and

FIG. 6 illustrates an example method for temporally-coherent image restoration using a diffusion model in accordance with this disclosure.

### DETAILED DESCRIPTION

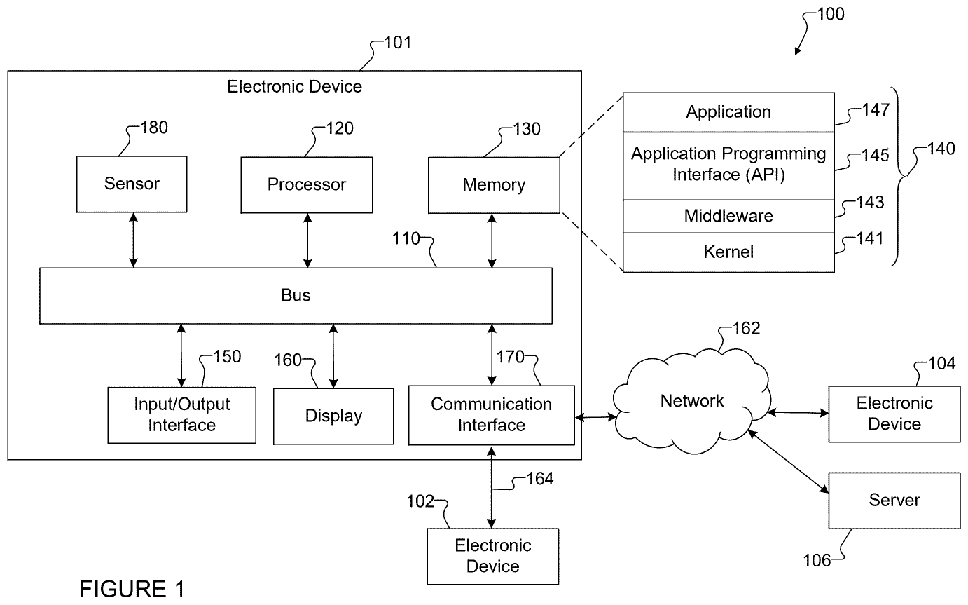

FIGS. 1 through 6, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, diffusion models have achieved state-of-the-art results in various image synthesis tasks. A diffusion model can be used in image synthesis by randomly generating a noise map and using the diffusion model to map the noise map to a realistic image. Since diffusion models can be easily conditioned, the diffusion models can be effectively applied to various image restoration tasks, such as image inpainting or outpainting, image denoising, and image super-resolution. With the powerful image generation capabilities of diffusion models, their image synthesis results are often much more realistic than previous approaches.

Unfortunately, applying diffusion models to sequences of image frames is problematic. For example, when applying a diffusion model to increase the resolution of image frames in a video sequence, the diffusion model can be applied in a frame-by-frame fashion to increase the resolution of each image frame individually. However, since diffusion models use random noise as initialization, this can cause temporally-incoherent restoration results to be achieved in the sequence of image frames. As a particular example, diffusion models can generate image frames in a video sequence that suffer from flicker artifacts due to the random noise used in the initial step of processing each image frame. These artifacts can greatly hinder the application of diffusion models in video restoration applications or other applications in which sequences of image frames are processed using the diffusion models.

Taking super-resolution as an example, a diffusion model can receive an image frame and randomly-generated noise. Concatenation or addition can be performed to combine these inputs, and an iterative denoising process can be used to cause the noise to become less and less noisy guided by the image frame. In some cases, there may be two randomness factors involved in this process, namely the initial random noise and an indeterministic sampler used in the iterative denoising process. For single-image super-resolution, the random noise is beneficial since it can increase the diversity of the generated results. However, for video super-resolution, the different randomly-generated noise used for each image frame can be problematic as it leads to temporally-incoherent results. Thus, those randomness factors should be removed while corresponding compensation is applied for stability in order to reduce or eliminate flicker artifacts or other temporally-incoherent results. For other video restoration tasks, a similar strategy could be applied, where the specific compensation that is applied can be application-dependent.

This disclosure provides for temporally-coherent image restoration using a diffusion model. As described in more detail below, first and second image frames can be obtained. In some cases, the image frames can represent image frames forming at least part of a video sequence or other sequence of sequential image frames. A first noise map can be generated for the first image frame. In some cases, the first noise map may represent a fixed noise map, such as a noise map containing random Gaussian noise. Motion information between the first image frame and the second image frame can be generated, and a second noise map for the second image frame can be generated based on the first noise map and the motion information. In some cases, the motion information may include measurable motion information or estimated motion information, and the second noise map may be generated by warping the first noise map based on the measurable motion information or interpolating the first noise map based on the estimated motion information. As a particular example, the motion information may be based on optical flow between the first and second image frames, and the second noise map may represent a warped noise map generated by warping the first noise map based on the optical flow. A first restored image frame based on the first image frame and the first noise map and a second restored image frame based on the second image frame and the second noise map can be generated using a trained diffusion model. In some cases, the first and second restored image frames may represent higher-resolution versions of the first and second image frames. In some embodiments, one or more additional image frames can be obtained. For each additional image frame, additional motion information between the additional image frame and a previous image frame can be determined, an additional noise map for the additional image frame can be generated based on a previous noise map associated with the previous image frame and the additional motion information, and an additional restored image frame can be generated based on the additional image frame and the additional noise map using the trained diffusion model.

In this way, the described techniques can significantly reduce or eliminate flicker artifacts or other artifacts in restored image frames generated using a diffusion model caused by temporally-incoherent results in the restored image frames. This can be achieved because the noise used in the restoration of subsequent image frames is based on the noise used in the restoration of previous image frames. Thus, for instance, the noise map associated with one image frame can be used as an “anchor” for noise maps associated with subsequent image frames. This allows all of the noise maps used with the image frames to contain or be based on the same random noise, and the resulting restored image frames based on these related noise maps can have fewer or no temporally-incoherent results.

Note that there are various applications and use cases in which this functionality may be used. For example, these techniques may be used in applications involving image inpainting or outpainting, image denoising, and image super-resolution. Image inpainting typically involves filling in missing image data in input image frames, which in some cases may include removing image data (possibly based on user input) from the input image frames and replacing the removed image data with other image data. Image outpainting typically involves adding image data along one or more sides of the input image frames, where that additional image data is consistent with the contents of the input image frames. Image denoising typically involves removing noise from image data in input image frames and replacing the noise with correct image data. Image super-resolution typically involves adding image data to lower-resolution input image frames in order to generate higher-resolution output image frames. As a particular example of image super-resolution, televisions or other displays, set-top boxes, TV boxes, or other devices may use this functionality in order to increase the resolution of images to be displayed to viewers. This may be useful, for instance, when presenting existing movies or other content having lower resolution (meaning content having a lower resolution than a display device on which the content is presented). As another particular example of image super-resolution, televisions or other displays, smartphones, or other devices may use this functionality in order to increase the resolution of images or videos captured using smartphone cameras or other cameras. As yet another example of image super-resolution, content providers may use this functionality to increase the resolution of content to be provided to users, and the processed content may be stored, streamed, or otherwise used. In general, however, this disclosure is not limited to any particular applications and use cases for the disclosed techniques.

This functionality may also be deployed in any suitable manner, such as when deployed as a trained machine learning model or other logic on an end user device (such as a smartphone, tablet computer, laptop computer, or other device) or when implemented by a server or in a cloud computing environment. In some cases, a trained machine learning model may be trained by one device and deployed for use by one or more other devices, such as when the machine learning model is trained by a server and deployed to mobile smartphones or other end user devices for use. In other cases, a trained machine learning model may be trained by a device and used by that same device. In general, however, this disclosure is not limited to any particular deployment of the described functionality.

In addition, it may often be assumed below that image frames in a sequence are processed sequentially, such as when a first image frame is associated with a first noise map, a second image frame is associated with a second noise map based on the first noise map, a third image frame is associated with a third noise map based on the second noise map, and so on. However, this particular sequential processing order is not necessarily required, and other approaches may be used. For instance, a first image frame may be associated with a first noise map, and each subsequent image frame may be associated with a noise map based on the first noise map. In general, as long as optical flow or other motion information can be determined between two image frames in a sequence (regardless of where those image frames appear in the sequence and regardless of whether those image frames are consecutive in the sequence), the motion map for the earlier image frame may be used to generate the motion map for the later image frame. As long as the motion maps for different image frames contain or are based on common noise that is modified for some of the image frames based on motion information between those image frames, the described techniques can be effective at reducing or eliminating flicker artifacts or other artifacts caused by temporally-incoherent results from a diffusion model.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to temporally-coherent image restoration using a diffusion model.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform temporally-coherent image restoration using a diffusion model. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user. Note that in other embodiments, the display 160 may be external to the electronic device 101.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 may include one or more sensors 180 that can meter a physical quantity or detect an activation state of the electronic device 101 and convert metered or detected information into an electrical signal. For example, the sensor(s) 180 may include one or more cameras or other imaging sensors, which may be used to capture images of scenes. The sensor(s) 180 may also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 may include one or more position sensors, such as an inertial measurement unit that can include one or more accelerometers, gyroscopes, and other components. In addition, the sensor(s) 180 may include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. In still other embodiments, the electronic device 101 can be a fixed or portable display device (such as a television) or an electronic device used in conjunction with a display device (such as a set-top box or TV box).

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to temporally-coherent image restoration using a diffusion model.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

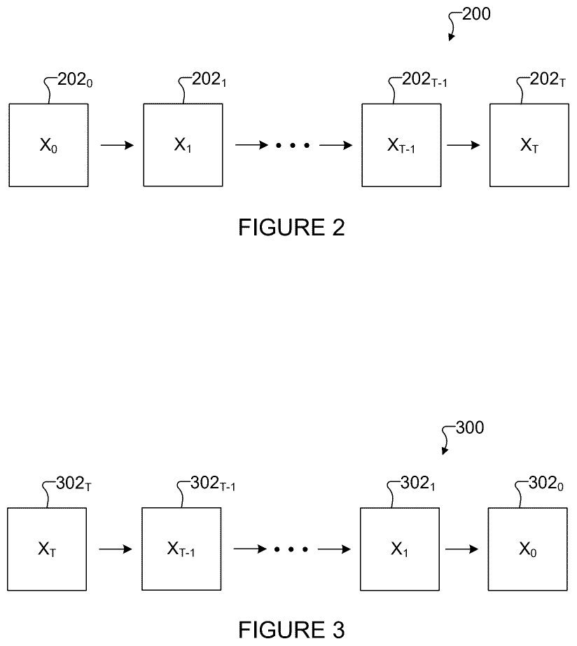

FIGS. 2 and 3 illustrate example forward and reverse diffusion processes 200 and 300 in accordance with this disclosure. As shown in FIG. 2, during the forward diffusion process 200, an input image 202₀ (also denoted X₀) is obtained and processed. More specifically, a small amount of Gaussian noise or other noise is iteratively added during each of T steps, resulting in the generation of T images 202₁-202_{T} (also denoted X₁-X_{T}). Each image in the sequence contains more noise than the preceding image in the sequence. The amount of noise added in each step can be controlled by a variance schedule, which can be expressed as {βₜ∈(0,1)}ₜ₌₁^{T}. The overall operation of the forward diffusion process 200 may be expressed as follows.

$$q ( {X}_{t} \vert {X}_{t - 1} ) = N ( {X}_{t} ; \sqrt{1 - {β}_{t}} {X}_{t - 1} , {β}_{t} I ) \\ q ( {X}_{1 : T} \vert {X}_{0} ) = {\prod }_{t = 1}^{T} q ( {X}_{t} \vert {X}_{t - 1} )$$

After a specified number of iterations (the T steps), the resulting image 202_{T} contains substantially pure noise, such as substantially only Gaussian noise.

As shown in FIG. 3, during the reverse diffusion process 300, an input image 302_{T} is obtained and processed. More specifically, the input image 302_{T} is a random noisy image, such as a random Gaussian image. The reverse diffusion process 300 operates to de-noise the input image 302_{T} during each of T steps, resulting in the generation of T images 302_{T-1}-302₀. Each image in the sequence contains less noise than the preceding image in the sequence. The removal of the noise is generally governed by two parameters, namely a mean (parameterized by μ_{θ}) and a variance (parameterized by Σ_{θ}). The overall operation of the reverse diffusion process 300 may be expressed as follows.

$${p}_{θ} = N ( {X}_{t - 1} ; {μ}_{θ} ( {X}_{t} , t ) , ) {\sum }_{θ} ( {X}_{t} , t ) \\ {p}_{θ} ( {X}_{0 : T} ) = p ( {X}_{T} ) {\prod }_{t = 1}^{T} {p}_{θ} ( {X}_{T - 1} \vert {X}_{T} )$$

After a specified number of iterations (the T steps), the resulting image 302₀ ideally contains little or no noise.

When a diffusion model is used for image synthesis, the forward diffusion process 200 and the reverse diffusion process 300 may be used during training of the diffusion model and inferencing by the diffusion model, respectively. During training, the forward diffusion process 200 can be used so that the diffusion model learns how original (clean) images can become noisier and noisier. Once trained, the diffusion model can be provided with noise, and the diffusion model repeatedly iterates to generate less-noisy images based on the original noise. For each iteration during the inferencing, the diffusion model estimates how a less-noisy image could be generated based on either the original noise (during the first iteration) or an image from the prior iteration (during each subsequent iteration). Ideally, each iteration of the inferencing produces a less-noisy image until a final noise-free image is obtained.

While use of a diffusion model in this manner is effective for image synthesis, it is generally less suitable for use during image restoration involving a sequence of image frames, such as when performing image inpainting, image denoising, or image super-resolution involving a sequence of image frames. This is because the noise used for each image frame in the sequence generally represents random noise, and the random noise is different for different image frames. Because of this, while each individual image frame may be effectively restored, the sequence of restored image frames can be temporally-incoherent, resulting in flicker artifacts or other artifacts. The techniques described below can help to modify operation of the diffusion model in order to reduce or avoid the generation of temporally-incoherent restored image frames in a sequence.

Although FIGS. 2 and 3 illustrate examples of forward and reverse diffusion processes 200 and 300, various changes may be made to FIGS. 2 and 3. For example, each of the forward and reverse diffusion processes 200 and 300 may include any suitable number of iterations.

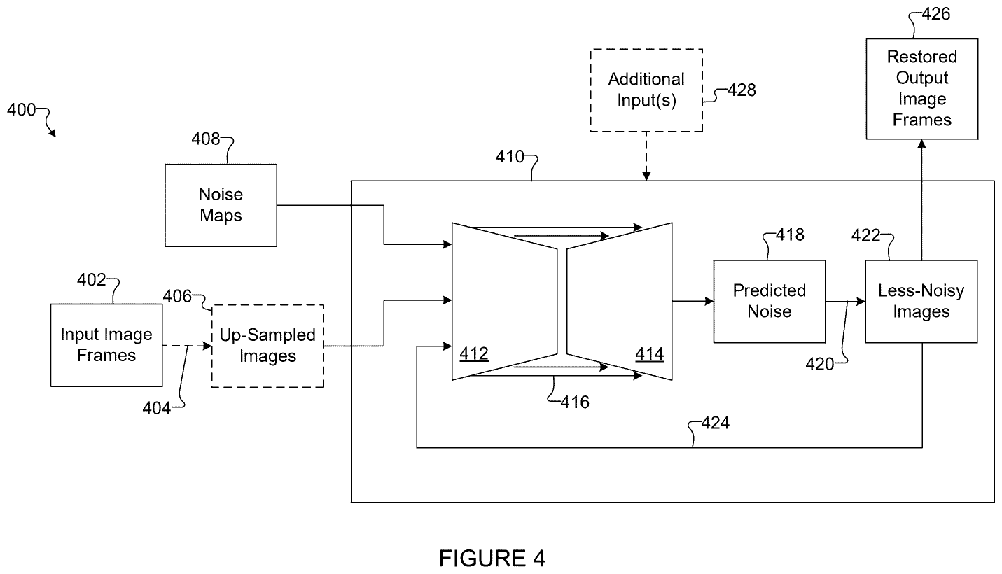

FIG. 4 illustrates an example architecture 400 supporting temporally-coherent image restoration using a diffusion model in accordance with this disclosure. For ease of explanation, the architecture 400 shown in FIG. 4 is described as being implemented using the electronic device 101 in the network configuration 100 shown in FIG. 1. However, the architecture 400 may be implemented using any other suitable device(s), such as the server 106, and in any other suitable system(s).

As shown in FIG. 4, the architecture 400 generally operates to receive input image frames 402 and generate restored output image frames 426, which represent higher-resolution or other improved versions of the input image frames 402. The input image frames 402 may be obtained from any suitable source(s). As examples, the input image frames 402 may be captured using at least one camera or other imaging sensor 180 of the electronic device 101, retrieved from a memory 130 of the electronic device 101, or obtained over the Internet or other network via at least one communication interface 170 of the electronic device 101. Any suitable number of input image frames 402 may be obtained here, such as when the input image frames 402 represent multiple image frames contained in a stream of image frames (such as a video sequence). Each input image frame 402 can have any suitable format, such as a red-green-blue (RGB) image format, a luma-chroma (YUV) image format, or a Bayer or other raw image format. Each input image frame 402 can also have any suitable resolution.

Each restored output image frame 426 can also have any suitable format and any suitable resolution. The restored output image frames 426 can differ from the input image frames 402 in various ways depending on the application. For instance, when the architecture 400 supports super-resolution, each output image frame 426 can have a higher resolution than its corresponding input image frame 402. When the architecture 400 supports image denoising, each output image frame 426 can have less noise than its corresponding input image frame 402. When the architecture 400 supports image inpainting or outpainting, each output image frame 426 can have image data not contained in its corresponding input image frame 402. Note that the architecture 400 can also support a combination of functions, such as two or more of image super-resolution, image denoising, image inpainting, and image outpainting.

Each input image frame 402 may optionally be provided to and processed using an up-scaling function 404, which generally operates to convert the input image frame 402 into an associated up-sampled image frame 406. Each up-sampled image frame 406 has more pixels and therefore a higher resolution than its corresponding input image frame 402. However, the up-scaling process can introduce noise into the up-sampled image frame 406. The specific amount of up-scaling here can depend on various factors, such as the actual resolution of each input image frame 402 and the desired resolution of the corresponding output image frame 426. In some cases, for instance, the desired resolution of each output image frame 426 may match the resolution of a display device to present the output image frame 426, and each up-sampled image frame 406 can have a resolution matching the desired resolution of the corresponding output image frame 426. The up-scaling function 404 can use any suitable technique to increase the amount of image data contained in input image frames 202, such as bilinear or bicubic up-sampling. Note, however, that the use of the up-scaling function 404 here is optional since the architecture 400 could process the input image frames 402 without up-scaling the input image frames 402.

The architecture 400 also receives, generates, or otherwise obtains noise maps 408, each of which contains noise used by the architecture 400 during processing of one or more of the input image frames 402. Each noise map 408 can include any suitable amount and type of noise. In some embodiments, for instance, each noise map 408 may contain or be based on randomly-generated Gaussian noise. Also, in some embodiments, each noise map 408 may have a resolution that matches the resolution of the corresponding input image frame 402 or up-sampled image frame 406 and/or a resolution that matches the resolution of the corresponding restored output image frame 426. As described in more detail below, when processing a sequence of input image frames 402, an anchor noise map 408 for one of the input image frames 402 may include random Gaussian noise or other noise, and the noise map(s) 408 for one or more subsequent input image frames 402 may represent warped, interpolated, or other modified versions of the anchor noise map 408.

A diffusion model 410 generally operates to process the input image frames 402 or up-sampled image frames 406 and their corresponding noise maps 408 in order to generate the restored output image frames 426. The diffusion model 410 represents a machine learning model that has been trained to identify and remove noise from image frames or to otherwise synthesize image data for inclusion in or with image frames. In some embodiments, the diffusion model 410 can be used to perform image super-resolution, image denoising, or image inpainting or outpainting. As a particular example, the up-sampled image frames 406 can have higher resolution than the original input image frames 402, and the resulting restored output image frames 426 represent higher-resolution versions of the input image frames 402. In other words, the diffusion model 410 can be being used to process higher-resolution versions of the input image frames 402 (the up-sampled image frames 406) in order to remove noise from the higher-resolution versions of the input image frames 402 and insert appropriate image data, thereby supporting super-resolution. Similar or other operations may be performed by the diffusion model 410 to support functions like image denoising, image inpainting, or image outpainting.

In this example, the diffusion model 410 includes an encoder 412, a decoder 414, and skip connections 416 between the encoder 412 and the decoder 414. In some embodiments, these components may form a “U-net” architecture based on the logical arrangement of the components within the encoder 412 and the decoder 414. The encoder 412 can be implemented using a convolutional network that includes multiple levels. Each of at least some levels of the convolutional network may include one or more convolutional layers, one or more rectified linear unit (ReLU) or other activation layers, and one or more max pooling or other pooling layers. The convolutional network generally operates to convert image data into features, where the levels of the convolutional network generate features in progressively fewer channels having progressively larger depths. Effectively, the encoder 412 captures contextual information within the image data while reducing the spatial dimensions of the data.

The decoder 414 can be implemented using a deconvolutional network that includes multiple levels. Each of at least some levels of the deconvolutional network may include one or more up-sampling layers and one or more deconvolutional layers. The deconvolutional network generally operates to convert the encoded features generated by the encoder 412 back into image data, where the levels of the deconvolutional network expand the features into progressively larger spatial dimensions at progressively smaller depths. Effectively, the decoder 414 can convert encoded features of image data back into image data. The skip connections 416 allow features generated at different levels of the encoder 412 to be provided to levels at the same resolution in the decoder 414.

As part of the operation of the diffusion model 410, predicted noise 418 is generated, which represents a prediction of the amount of noise contained in the input image frame 402 or up-sampled image frame 406. Through the use of a noise scheduler 420, a portion of the predicted noise 418 is removed from the image data of the input image frame 402 or up-sampled image frame 406, resulting in the generation of a less-noisy image frame 422. In some embodiments, the noise scheduler 420 may be implemented using a denoising diffusion implicit model (DDIM). In particular embodiments, each less-noisy image frame 422 may be generated from a current image frame as defined in the following manner.

$${x}_{t - 1} = \sqrt{{\overline{α}}_{t - 1}} ( \frac{{x}_{t} - \sqrt{1 - {\overline{α}}_{t}} {ϵ}_{θ}^{( t )} ( {x}_{t} )}{\sqrt{{\overline{α}}_{t}}} ) + \sqrt{1 - {\overline{α}}_{t - 1}} {ϵ}_{θ}^{( t )}$$

This represents a DDIM-based denoising equation in which t represents the step or iteration number and α̅ₜ and α̅ₜ₋₁ represent weights respectively applied to image data in current and prior image frames.

As shown in this example, the encoder 412 and the decoder 414 are used repeatedly as part of an iterative process. During this iterative process, the less-noisy image frame 422 can be provided as feedback 424, where the less-noisy image frame 422 is input to the encoder 412. The next iteration can occur, leading to the generation of predicted noise 418 contained in the less-noisy image frame 422. This results in the generation of the next less-noisy image frame 422, which can be provided as feedback 424 and input to the encoder 412 again. This can be repeated any number of times until the less-noisy image frame 422 that is generated is output as a restored output image frame 426.

Depending on the implementation, the diffusion model 410 may receive one or more additional inputs 428 that can be used by the diffusion model 410 during processing of the input image frames 402 or the up-sampled image frames 406. The one or more additional inputs 428 may represent any suitable information that could be used by the diffusion model 410 during generation of the restored output image frames 426. For example, the one or more additional inputs 428 could represent at least one text prompt or other prompt provided by a user, where the prompt(s) can provide useful information informing the diffusion model 410 how to process the input image frames 402. As another example, the one or more additional inputs 428 could include one or more segmentation maps that indicate how the input image frames 402 can be segmented. Each segmentation map may, for instance, identify pixels in one or more associated input image frames 402 associated with people, certain objects (like vehicles, buildings, street signs, or trees or other foliage), the sky, the ground, and background objects (like mountains). In whatever form, the diffusion model 410 could use the one or more additional inputs 428 to help guide the process performed by the diffusion model 410 when generating the restored output image frames 426.

Although FIG. 4 illustrates one example of an architecture 400 supporting temporally-coherent image restoration using a diffusion model, various changes may be made to FIG. 4. For example, various components or functions in FIG. 4 may be combined, further subdivided, replicated, omitted, or rearranged and additional components or functions may be added according to particular needs.

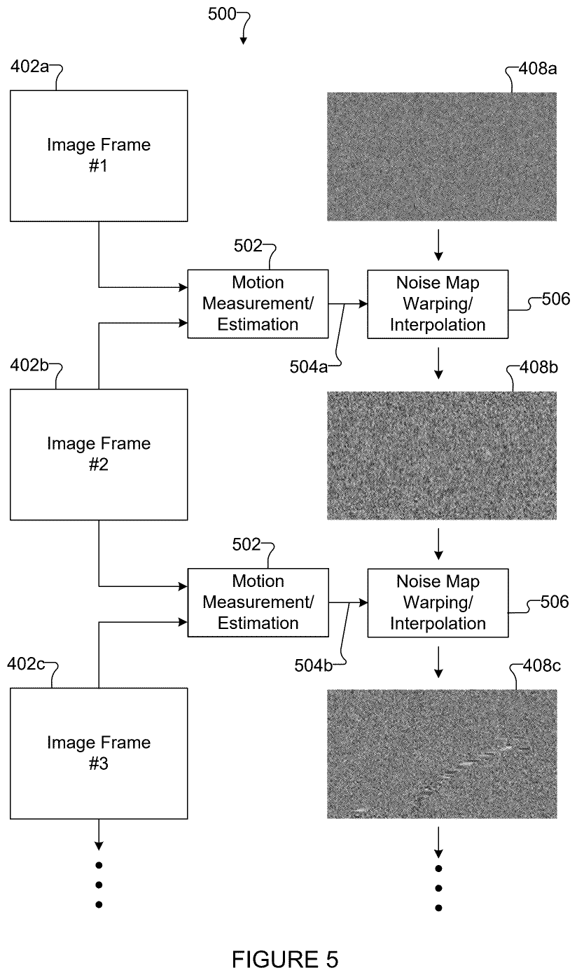

FIG. 5 illustrates an example process 500 for modifying noise maps to support temporally-coherent image restoration using a diffusion model in accordance with this disclosure. For ease of explanation, the process 500 shown in FIG. 5 is described as being performed as part of the functionality of the architecture 400 shown in FIG. 4, which may be implemented using the electronic device 101 in the network configuration 100 shown in FIG. 1. However, the process 500 may be performed using any other suitable device(s), such as the server 106, and any other suitable architecture(s), and the process 500 may be performed in any other suitable system(s).

As shown in FIG. 5, a sequence of input image frames 402a-402c is being processed by the diffusion model 410 in the architecture 400. Note that the input image frames 402a-402c here may be replaced by up-sampled versions of those input image frames 402a-402c as generated by the up-scaling function 404. A noise map 408a associated with the input image frame 402a can be generated and used by the diffusion model 410 when generating a restored output image frame 426 corresponding to the input image frame 402a. As described below, the noise map 408a can represent an “anchor” noise map from which other noise maps are generated. This part of the process 500 may be viewed as including an initialization of the anchor noise map.

For the next input image frame 402b (or an up-scaled version thereof), using a noise map containing new random noise may result in the generation of flicker artifacts or other artifacts due to temporally-incoherent restoration results. To help overcome this type of issue, a noise map 408b for the input image frame 402b is generated based on the noise map 408a for a previous input image frame 402a. In this example, a motion measurement or estimation function 502 can process the input image frames 402a and 402b and generate motion information 504a. The motion information 504a identifies measurements or estimates of the motion that occurs between the contents of the input image frame 402a and the contents of the input image frame 402b. The motion measurement or estimation function 502 may use any suitable technique to identify motion that occurs between different image frames.

In some embodiments, the motion measurement or estimation function 502 may perform optical flow estimation. Optical flow estimation refers to a technique for estimating motion for each pixel between two image frames, and the results of the optical flow estimation can be referred to as an optical flow map. The optical flow map can identify the apparent motion captured between the two image frames. This type of approach can be useful in image super-resolution applications, image denoising applications, or other applications where image data in all regions of the input image frames 402a-402b is available. In other embodiments, the motion measurement or estimation function 502 may measure or estimate motion in one or more regions of the input image frames 402a-402b to estimate optical flow, and the results can be used to interpolate motion in one or more other regions of the of the input image frames 402a-402b. This type of approach can be useful in image inpainting or outpainting applications or other applications where image data in certain regions of the input image frames 402a-402b is not available, in which case optical flow in the available regions of the input image frames 402a-402b can be used to estimate optical flow in the unavailable regions of the input image frames 402a-402b. Note, however, that the motion information 504a between image frames can be generated in any other suitable manner.

Based on the motion information 504a, a noise map warping or interpolation function 506 can apply the motion information 504a to the noise map 408a in order to generate a noise map 408b for the input image frame 402b (or an up-scaled version thereof). For example, optical flow as defined by the motion information 504a can be used by the noise map warping or interpolation function 506 to warp the noise map 408a for a previous input image frame 402a in order to generate the noise map 408b for a subsequent input image frame 402b. Here, the noise map 408a is being warped based on the identified optical flow to produce the noise map 408b. If needed, the noise map warping or interpolation function 506 can perform interpolation to estimate noise data in one or more areas of the noise map 408b, such as when the noise data for inpainted or outpainted areas associated with the input image frame 402b is interpolated.

As can be seen here, this approach generates the noise map 408b for the input image frame 402b not by generating new random noise but by generating the noise map 408b based on the noise contained in the noise map 408a. As a result, the diffusion model 410 generates the restored output image frame 426 for the input image frame 402b using the noise map 408b, and the restored output image frame 426 for the input image frame 402b can be substantially temporally-consistent with the restored output image frame 426 generated by the diffusion model 410 for the input image frame 402a.

Similarly, for the next input image frame 402c (or an up-scaled version thereof), a noise map 408c for the input image frame 402c is generated based on the noise map 408a or 408b for a previous input image frame 402a or 402b. In this example, the noise map 408c is generated based on the noise map 408b, although the noise map 408c could be generated based on the noise map 408a by modifying the data flows in FIG. 5. Here, the motion measurement or estimation function 502 can process the input image frames 402b and 402c and generate motion information 504b. Based on the motion information 504b, the noise map warping or interpolation function 506 can apply the motion information 504b to the noise map 408b in order to generate a noise map 408c for the input image frame 402c (or an up-scaled version thereof). This approach generates the noise map 408c not by generating new random noise but by generating the noise map 408c based on the noise contained in the noise map 408b. As a result, the diffusion model 410 generates the restored output image frame 426 for the input image frame 402c using the noise map 408c, and the restored output image frame 426 for the input image frame 402c can be substantially temporally-consistent with the restored output image frames 426 generated by the diffusion model 410 for the input image frames 402a and 402b.

This part of the process 500 may be viewed as being a propagation of the anchor noise map to any suitable number of additional noise maps. The process 500 can continue operating in this manner to propagate the anchor noise map to additional noise maps for additional image frames. In some cases, the propagation could continue until the scene captured in the image frames changes significantly, such as due to a scene cut or other rapid change in scene contents. When that occurs, the process 500 can begin again by generating a new random noise map 408a for a new image frame 402a associated with the new scene contents and using the noise map 408a as an anchor noise map for any suitable number of additional image frames.

In this way, the process 500 allows the motion information 504a-504b to represent measurable or estimated motion information, which can be applied to modify the noise maps for prior image frames in order to generate the noise maps for subsequent image frames. In some cases, if the motion information 504a or 504b represents actual measured motion between two image frames, warping may be used in at least part of the noise map for the prior image frame in order to generate the noise map for the subsequent image frame. If the motion information 504a or 504b represents estimated motion between two image frames, interpolation may be used in at least part of the noise map for the prior image frame in order to generate the noise map for the subsequent image frame. In general, however, any suitable motion information may be used to modify the noise map for a prior image frame in order to generate the noise map for a subsequent image frame. In whatever manner the noise map for the prior image frame is modified, the result is that the anchor noise map may include random Gaussian or other noise, and each subsequent noise map in the sequence may include or be based on the Gaussian or other noise from a prior noise map as modified based on motion information 504a-504b.

Although FIG. 5 illustrates one example of a process 500 for modifying noise maps to support temporally-coherent image restoration using a diffusion model, various changes may be made to FIG. 5. For example, to generate the noise map 408c, the motion measurement or estimation function 502 could compare the image frames 402a and 402c (or up-scaled versions thereof), and the noise map warping or interpolation function 506 could apply the resulting motion information 504b to modify the noise map 408a in order to generate the noise map 408c. In other words, the noise map for any earlier image frame could be used to generate the noise map for any subsequent image frame as long as suitable motion information can be produced between those image frames.

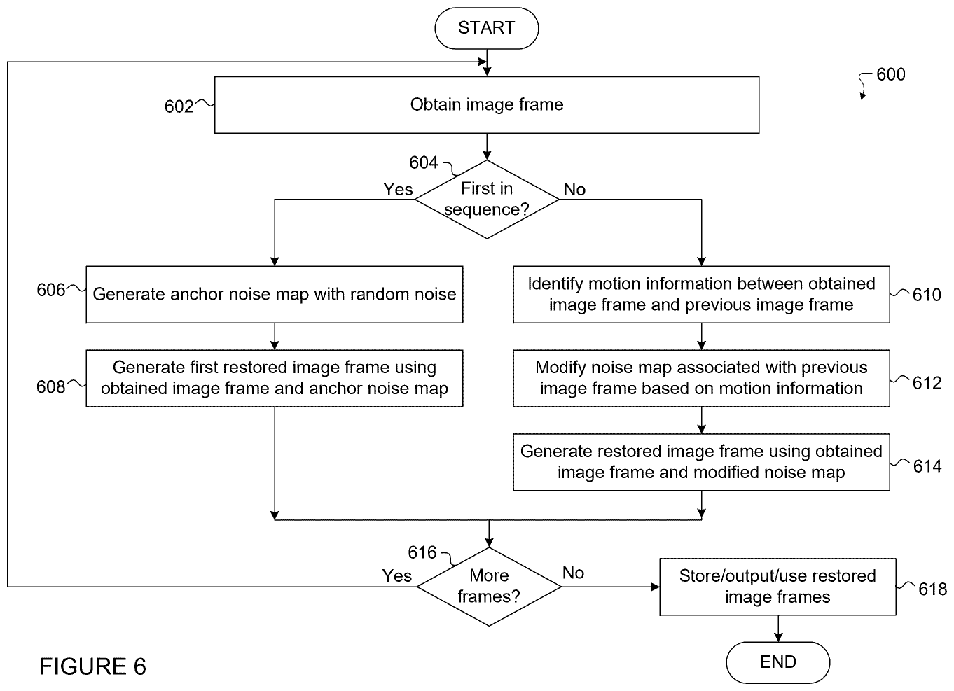

FIG. 6 illustrates an example method 600 for temporally-coherent image restoration using a diffusion model in accordance with this disclosure. For ease of explanation, the method 600 shown in FIG. 6 is described as being performed by the electronic device 101 in the network configuration 100 shown in FIG. 1, where the electronic device 101 supports the architecture 400 shown in FIG. 4 and the process 500 shown in FIG. 5. However, the method 600 shown in FIG. 6 could be performed using any other suitable device(s) and architecture(s) and in any other suitable system(s).

As shown in FIG. 6, an image frame is obtained at step 602. This may include, for example, the processor 120 of the electronic device 101 obtaining an input image frame 402, which may be captured using at least one camera or other imaging sensor 180 of the electronic device 101, obtained from a memory 130 of the electronic device 101, obtained over the Internet or other network via at least one communication interface 170 of the electronic device 101, or obtained in any other suitable manner. Any desired pre-processing of the input image frame 402 may be performed here, such as up-scaling the input image frame 402 to generate an up-sampled image frame.

A determination is made whether the image frame is the first image frame in a sequence at step 604. This may include, for example, the processor 120 of the electronic device 101 determining whether the obtained image frame 402 or 406 is the first image frame in a video sequence or a portion thereof (such as the first image frame in a new scene in the video sequence). If so, an anchor noise map is generated at step 606, and a first restored image frame is generated using the obtained image frame and the anchor noise map at step 608. This may include, for example, the processor 120 of the electronic device 101 generating a noise map 408 containing random Gaussian noise or other random noise. This may also include the processor 120 of the electronic device 101 providing the obtained image frame 402 or 406 and the noise map 408 to the diffusion model 410. This may further include the processor 120 of the electronic device 101 using the diffusion model 410 to iteratively perform a noise removal process or other image restoration process to convert the obtained image frame 402 or 406 into a restored output image frame 426.

If the obtained image frame is not the first image frame in a sequence, motion information between the obtained image frame and a previous image frame is identified at step 610. This may include, for example, the processor 120 of the electronic device 101 performing the motion measurement or estimation function 502 to identify optical flow between the obtained image frame 402 or 406 and a previous image frame 402 or 406 and generating motion information 504a, 504b based on the optical flow. In some cases, the previous image frame 402 or 406 may represent the immediately-preceding image frame in the sequence. A noise map associated with the previous image frame is modified based on the motion information at step 612. This may include, for example, the processor 120 of the electronic device 101 performing the noise map warping or interpolation function 506 to warp, interpolate, or otherwise modify the noise map 408 associated with the previous image frame 402 or 406 in order to generate a noise map 408 for the obtained image frame 402 or 406. An additional restored image frame is generated using the obtained image frame and the modified noise map at step 614. This may include, for example, the processor 120 of the electronic device 101 providing the obtained image frame 402 or 406 and the modified noise map 408 to the diffusion model 410. This may also include the processor 120 of the electronic device 101 using the diffusion model 410 to iteratively perform a noise removal process or other image restoration process to convert the obtained image frame 402 or 406 into an additional restored output image frame 426.

A determination is made whether additional image frames can be processed at step 616. This may include, for example, the processor 120 of the electronic device 101 determining whether there are additional image frames in the sequence to be processed. If so, the method 600 returns to step 602 to obtain and process the next image frame 402. Otherwise, processing of the sequence is complete, and the restored output image frames may be stored, output, or used in some manner at step 616. This may include, for example, the processor 120 of the electronic device 101 initiating presentation of the restored output image frames 426 on a display 160 of the electronic device 101 or on the display of another device, storing the restored output image frames 426 in the memory 130 of the electronic device 101 or in the memory of another device, or using the restored output image frames 426 in any other suitable manner. In general, this disclosure is not limited to any particular use of the restored output image frames 426.

Although FIG. 6 illustrates one example of a method 600 for temporally-coherent image restoration using a diffusion model, various changes may be made to FIG. 6. For example, various steps in FIG. 6 may overlap, occur in series or in parallel, occur in a different order, or occur any number of times (including zero times). As a particular example, the method 600 may be repeated any number of times to process any suitable number of image sequences. As another particular example, restored output image frames 426 may be generated and displayed as image frames 402 or 406 are received and processed, meaning there is no need to wait for all image frames 402 or 406 to be received and processed before storing, outputting, or using the restored output image frames 426.

It should be noted that the functions shown in or described with respect to FIGS. 2 through 6 can be implemented in an electronic device 101, 102, 104, server 106, or other device(s) in any suitable manner. For example, in some embodiments, at least some of the functions shown in or described with respect to FIGS. 2 through 6 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 6 can be implemented or supported using dedicated hardware components. In general, the functions shown in or described with respect to FIGS. 2 through 6 can be performed using any suitable hardware or any suitable combination of hardware and software/firmware instructions. Also, the functions shown in or described with respect to FIGS. 2 through 6 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using at least one processing device of an electronic device, first and second image frames;
generating, using the at least one processing device, a first noise map for the first image frame;
determining, using the at least one processing device, motion information between the first image frame and the second image frame;
generating, using the at least one processing device, a second noise map for the second image frame based on the first noise map and the motion information; and
generating, using the at least one processing device, a first restored image frame based on the first image frame and the first noise map and a second restored image frame based on the second image frame and the second noise map using a trained diffusion model.

2. The method of claim 1, wherein:
the first image frame and the second image frame represent consecutive image frames in a video; and
the first and second restored image frames form a portion of a higher-resolution video.

3. The method of claim 1, wherein the first noise map represents a fixed noise map.

4. The method of claim 1, wherein:
the motion information comprises measurable motion information or estimated motion information; and
the second noise map comprises (i) a warped noise map generated by warping the first noise map based on the measurable motion information or (ii) an interpolated noise map generated by interpolating the first noise map based on the estimated motion information.

5. The method of claim 1, wherein:
the motion information comprises measurable motion information based on optical flow between the first image frame and the second image frame; and
the second noise map comprises a warped noise map generated by warping the first noise map based on the measurable motion information.

6. The method of claim 1, further comprising:
obtaining one or more additional image frames after the second image frame; and
for each additional image frame:
determining additional motion information between the additional image frame and a previous image frame;
generating an additional noise map for the additional image frame based on a previous noise map associated with the previous image frame and the additional motion information; and
generating an additional restored image frame based on the additional image frame and the additional noise map using the trained diffusion model.

7. The method of claim 1, wherein:
the first noise map comprises Gaussian noise; and
the second noise map comprises the Gaussian noise as modified based on the motion information.

8. An electronic device comprising:
at least one processing device configured to:
obtain first and second image frames;
generate a first noise map for the first image frame;
determine motion information between the first image frame and the second image frame;
generate a second noise map for the second image frame based on the first noise map and the motion information; and
generate a first restored image frame based on the first image frame and the first noise map and a second restored image frame based on the second image frame and the second noise map using a trained diffusion model.

9. The electronic device of claim 8, wherein:
the first image frame and the second image frame represent consecutive image frames in a video; and
the first and second restored image frames form a portion of a higher-resolution video.

10. The electronic device of claim 8, wherein the first noise map represents a fixed noise map.

11. The electronic device of claim 8, wherein:
the motion information comprises measurable motion information or estimated motion information; and
the second noise map comprises (i) a warped noise map generated by warping the first noise map based on the measurable motion information or (ii) an interpolated noise map generated by interpolating the first noise map based on the estimated motion information.

12. The electronic device of claim 8, wherein:
the motion information comprises measurable motion information based on optical flow between the first image frame and the second image frame; and
the second noise map comprises a warped noise map generated by warping the first noise map based on the measurable motion information.

13. The electronic device of claim 8, wherein the at least one processing device is further configured to:
obtain one or more additional image frames after the second image frame; and
for each additional image frame:
determine additional motion information between the additional image frame and a previous image frame;
generate an additional noise map for the additional image frame based on a previous noise map associated with the previous image frame and the additional motion information; and
generate an additional restored image frame based on the additional image frame and the additional noise map using the trained diffusion model.

14. The electronic device of claim 8, wherein:
the first noise map comprises Gaussian noise; and
the second noise map comprises the Gaussian noise as modified based on the motion information.

15. A non-transitory machine readable medium containing instructions that when executed cause at least one processor of an electronic device to:
obtain first and second image frames;
generate a first noise map for the first image frame;
determine motion information between the first image frame and the second image frame;
generate a second noise map for the second image frame based on the first noise map and the motion information; and
generate a first restored image frame based on the first image frame and the first noise map and a second restored image frame based on the second image frame and the second noise map using a trained diffusion model.

16. The non-transitory machine readable medium of claim 15, wherein:
the first image frame and the second image frame represent consecutive image frames in a video; and
the first and second restored image frames form a portion of a higher-resolution video.

17. The non-transitory machine readable medium of claim 15, wherein:
the motion information comprises measurable motion information or estimated motion information; and
the second noise map comprises (i) a warped noise map generated by warping the first noise map based on the measurable motion information or (ii) an interpolated noise map generated by interpolating the first noise map based on the estimated motion information.

18. The non-transitory machine readable medium of claim 15, wherein:
the motion information comprises measurable motion information based on optical flow between the first image frame and the second image frame; and
the second noise map comprises a warped noise map generated by warping the first noise map based on the measurable motion information.

19. The non-transitory machine readable medium of claim 15, further containing instructions that when executed cause the at least one processor to:
obtain one or more additional image frames after the second image frame; and
for each additional image frame:
determine additional motion information between the additional image frame and a previous image frame;
generate an additional noise map for the additional image frame based on a previous noise map associated with the previous image frame and the additional motion information; and
generate an additional restored image frame based on the additional image frame and the additional noise map using the trained diffusion model.

20. The non-transitory machine readable medium of claim 15, wherein:
the first noise map comprises Gaussian noise; and
the second noise map comprises the Gaussian noise as modified based on the motion information.
